(19) United States
(12) Patent Application Publication
(10) Pub. No.: US 2012/0239979 A1
(43) Pub. Date: Sep. 20, 2012

(54) RADIO DEVICE, COMMUNICATION CONTROL METHOD, AND RADIO COMMUNICATION SYSTEM

(75) Inventor: Takahiro YUZAWA, Kawasaki (JP)

(73) Assignee: FUJITSU LIMITED, Kawasaki-shi (JP)

(21) Appl. No.: 13/417,666

(22) Filed: Mar. 12, 2012

(30) Foreign Application Priority Data
Mar. 17, 2011 (JP) 2011-059767

(51) Int. Cl. G06F 11/28

(52) U.S. Cl. 714/37; 714/E11.178

(57) ABSTRACT

A test method which is performed by a computer, the test method includes reducing a first period of timer interruption to a second period by multiplying the first period by a prescribed coefficient; converting, by using the computer, a wait time of a task, which waits for processing operating asynchronously with the timer interruption, into a first periodicity which is obtained by dividing the second period; obtaining a second periodicity by dividing the first periodicity by the prescribed coefficient; and determining the timer interruption on the basis of the second periodicity.

### CROSS-REFERENCE TO RELATED APPLICATIONS

This application is based upon and claims the benefit of priority from the prior Japanese Patent Application No. 2011-59767 filed on Mar. 17, 2011, the entire contents of which are incorporated herein by reference.

### FIELD

The embodiments discussed herein are related to a test method, a test program, and an information processing device.

### BACKGROUND

A software error may occur when an operation state continues for a long period of time. For example, as one of the reasons causing the above-described errors, a value of a variable is continuously incremented or decremented in a certain period, so that overflow or underflow of the variable is generated. There is a problem that the overflow generation and the like are desired to be prevented. Depending on the length of the certain period, a test for detecting the above-described error may take a long time. Conventionally, an acceleration test of software has been performed. A method for accelerating a variable or a method for accelerating a time of software have been known as a method of the acceleration test (see, for example, Japanese Laid-open Patent Publication No. 2004-38350).

According to the method of accelerating the variable, the variable that is incremented or decremented in the certain period are subjected to increment operation or decrement operation from outside the software to be tested. As a result, the variable may be incremented and decremented in a period that is shorter than the certain period. For example, regarding the variable that is incremented by an Operating System (OS) if the interruption is generated by the hardware in the certain period.

However, according to the method for accelerating the variable, the whole of the software to be tested may not be accelerated because the accelerated variable is limited to the variable that is referable and updatable.

On the other hand, according to the method for accelerating the time of software, a timer interruption period by hardware is accelerated, so that the time desired to recognize the software is accelerated. In general, a CPU reduces the set counter value in a prescribed period and generates timer interruption when the counter value indicates 0. According to the timer interruption, an OS performs updating of a time managed by the OS, dispatch of the task, or the like. At the time of the accelerating test, the timer interruption period may be shortened by reducing the counter value set to the CPU. As a result, time elapse managed by the OS, the dispatch of the task, or the like is accelerated. Each of the tasks is scheduled to be performed after an arbitrary time elapse. If the time elapse is accelerated, the acceleration test of the OS and the whole software operating on the OS may be performed. For example, Japanese Laid-open Patent Publication No. 2007-34672 is disclosed as a related art.

However, regarding the method of accelerating the time of software (the timer interruption period), there is a problem of a task that accesses the hardware operating asynchronously with the timer interruption and waits for a reply of the hardware. That is, while the reply waiting time of the task is accelerated, the processing of the hardware is not accelerated. As a result, even if the task is waked up (or recovered) from the reply waiting, the reply from the hardware may not be obtained. Thus, an error such as timeout may be recognized.

This will be described in detail with reference to the attached diagrams. FIG. 1 is a diagram illustrating an example of a relation between the task operation and the time when the timer interruption period is not accelerated.

FIG. 1 illustrates a start timing of processing for each performance subject of the processing. That is, the horizontal direction illustrated in FIG. 1 indicates a time axis. In FIG. 1, the timer interruption period indicates 4 milliseconds. For each timer interruption period, the attached numeral values (0 to 24) indicate relative real times (milliseconds) from the start illustrated in FIG. 1. On the other hand, in the vertical direction, a task scheduler, a task 1, a task 2, a task 3, peripheral hardware, and the like are allocated as the performance subject of the processing.

The task scheduler includes a timer list as schedule information used to start a task after a certain time and performs processing for waking up the task. The task 1, the task 2, and the task 3 are registered in the task scheduler. The peripheral hardware is, for example, a memory, a Hard Disk Drive (HDD), and the like that are to be accessed by the task.

Here, the description will be focused on the operation of the task 3. At a time 8, after transmitting the processing request to the peripheral hardware, the task 3 requests the OS to wait for 16 milliseconds. This is because the end of the peripheral hardware is waited. The task scheduler converts the wait time into a periodicity of the timer interruption. In this case, the wait time is converted into the period 16÷4=4. The task scheduler starts the task 3 at a time 24 after 4 periods. On the other hand, the processing of the peripheral hardware is completed at a time 20 after 12 milliseconds from the start. Therefore, the task 3 started at a time 24 may obtain the reply from the peripheral hardware and continue the continuous processing.

On the other hand, FIG. 2 is a diagram illustrating an example of a relation between the task operation and the time when the timer interruption period is accelerated by half. The perspective of FIG. 2 is equivalent to FIG. 1.

In FIG. 2, the timer interruption period is accelerated up to 2 milliseconds. The processing content of the task 3 is equivalent to FIG. 1. That is, after transmitting the processing request to the peripheral hardware at the time 2, the task 3 starts the wait for 16 milliseconds. The time 2 illustrated in FIG. 2 indicates the third period of the periodicity of the timer interruption. As for the task 3 and the task scheduler, the time 2 corresponds to the similar timing of the time 4 illustrated in FIG. 1.

The task scheduler converts the wait time into the periodicity of the timer interruption. In this case, the wait time is converted into the period 16÷4=4. The task scheduler does not recognize that the timer interruption period is accelerated. The conversion formula for the counter value is equivalent to the case of FIG. 1. The task scheduler wakes up the task 3 at a time 12 after 4 periods. On the other hand, the processing of the peripheral hardware is not completed until the time elapses to a time 16 which is after 12 milliseconds after the start. Accordingly, the task 3 started at the time 12 may not obtain the reply from the peripheral hardware, so that the task 3 recognizes the timeout or the like.

### SUMMARY

According to an aspect of the invention, a test method which is performed by a computer, the test method includes reducing a first period of timer interruption to a second period by multiplying the first period by a prescribed coefficient; converting, by using the computer, a wait time of a task, which waits for processing operating asynchronously with the timer interruption, into a first periodicity which is obtained by dividing the second period; obtaining a second periodicity by dividing the first periodicity by the prescribed coefficient; and determining the timer interruption on the basis of the second periodicity.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a diagram illustrating an example of a relation between a task operation and a time when a timer interruption period is not accelerated;

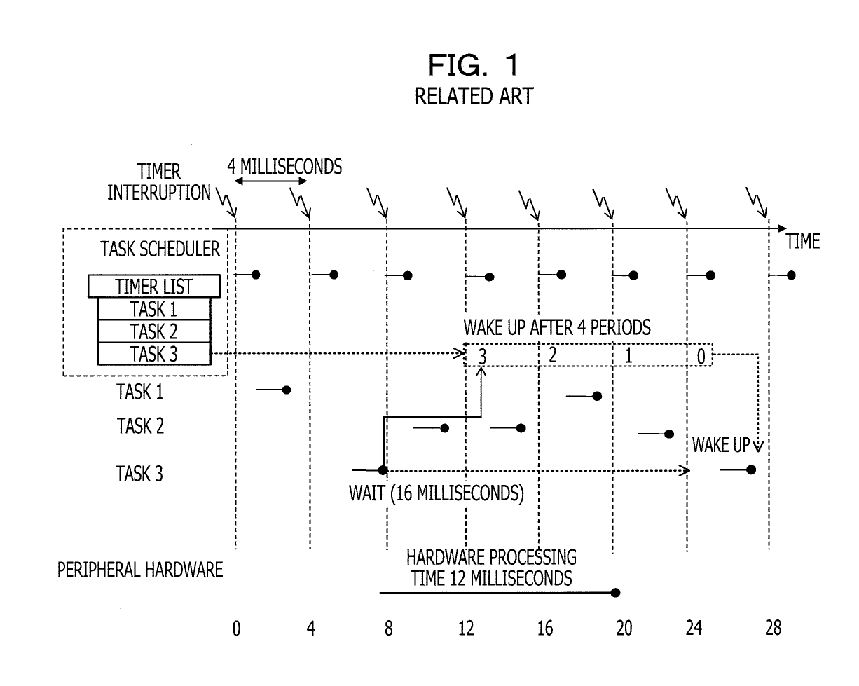

FIG. 2 is a diagram illustrating an example of the relation between the task operation and the time when the timer interruption period is accelerated by half.

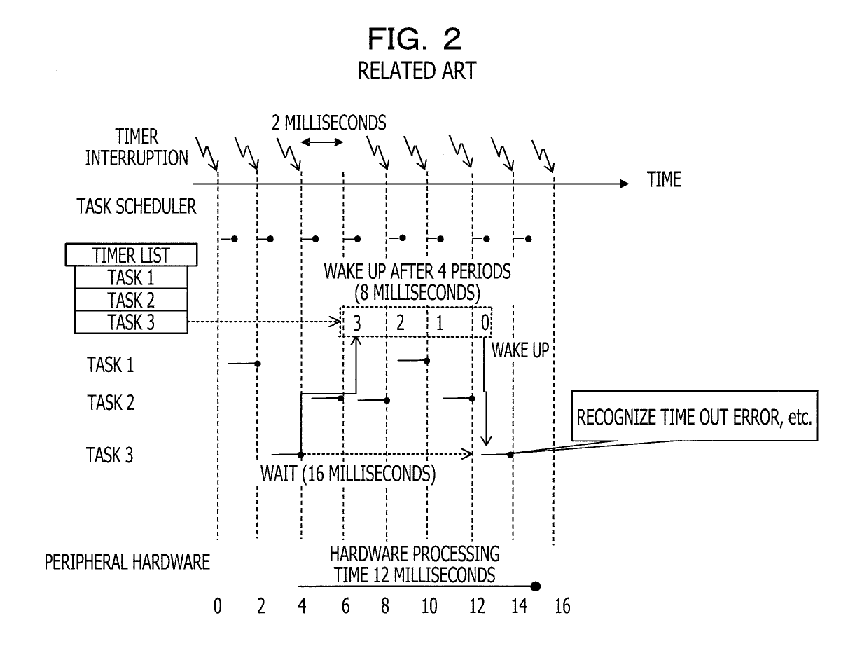

FIG. 3 is a diagram illustrating an example of a hardware configuration of a test device according to an embodiment of the present invention;

FIG. 4 is a diagram illustrating an example of a function configuration of a test device according to a first embodiment;

FIG. 5 is a flowchart illustrating an example of a processing procedure performed by an acceleration value receiving unit;

FIG. 6 is a diagram illustrating an example of a function configuration of a wait processing unit according to the first embodiment;

FIG. 7 is a flowchart illustrating an example of a processing procedure performed by the wait processing unit according to the first embodiment;

FIG. 8 is a flowchart illustrating an example of a processing procedure performed by an acceleration eliminating unit;

FIG. 9 is a flowchart illustrating an example of a processing procedure of the whole test device;

FIG. 10 is a diagram illustrating a specific example of an operation of a test device when the timer interruption period is not accelerated;

FIG. 11 is a diagram illustrating an example of a relation between the task operation and the time in the test device when the timer interruption period is not accelerated;

FIG. 12 is a diagram illustrating an example of the operation of the test device when the timer interruption period is accelerated;

FIG. 13 is a diagram illustrating an example of the relation between the task operation and the time in the test device when the timer interruption period is accelerated by half;

FIG. 14 is a diagram illustrating an example of a function configuration of a wait processing unit according to a second embodiment;

FIG. 15 is a diagram illustrating a third embodiment;

FIG. 16 is a diagram illustrating a fourth embodiment;

FIG. 17 is a diagram illustrating an example of an operation of the test task and a tested device according to the fourth embodiment; and

FIGS. 18A and 18B are diagrams illustrating a deformation example of a program according to a test task of the fourth embodiment.

### DESCRIPTION OF EMBODIMENTS

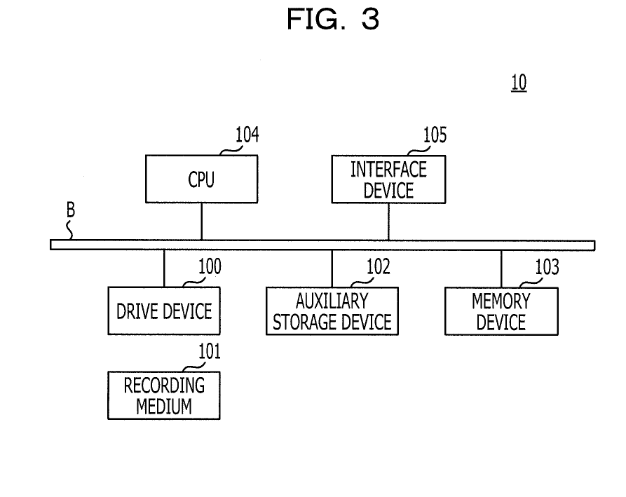

With reference to the attached diagrams, embodiments of the present invention will be described below. FIG. 3 is a diagram illustrating an example of a hardware configuration of a test device according to an embodiment of the present invention. In FIG. 3, a test device 10 includes a drive device 100, an auxiliary storage device 102, a memory device 103, a CPU 104, an interface device 105, and the like that are coupled with each other by a bus B.

A program that achieves processing in the test device 10 is provided by a recording medium 101. For example, when the recording medium 101 that records a program is set to the drive device 100, the program is installed from the recording medium 101 into the auxiliary storage device 102 through the drive device 100. However, the program is not typically installed from the recording medium 101. The program may be downloaded from another computer through a network. The auxiliary storage device 102 stores desired files or data as well as the installed program.

In a case of a start instruction of the program, the memory device 103 reads out and stores the program from the auxiliary storage device 102. The CPU 104 performs a function related to the test device 10 according to the program stored in the memory device 103. The interface device 105 is used to be coupled with a network. The number of memory devices 103 and CPUs 104 provided inside the test device 10 according to purposes may be more than one.

A portable recording medium such as a CD-ROM, a DVD disc, a USB memory, and the like are given as an example of the recording medium 101. A Hard Disk Drive (HDD), a flash memory, and the like are given as an example of the auxiliary storage device 102. Both the recording medium 101 and the auxiliary storage device 102 correspond to a computer-readable recording medium.

An input device such as a mouse and a keyboard or a display device such as a liquid crystal display may be coupled with the test device 10. If the test device 10 is not typically coupled with the network, the test device 10 does not typically have the interface device 105.

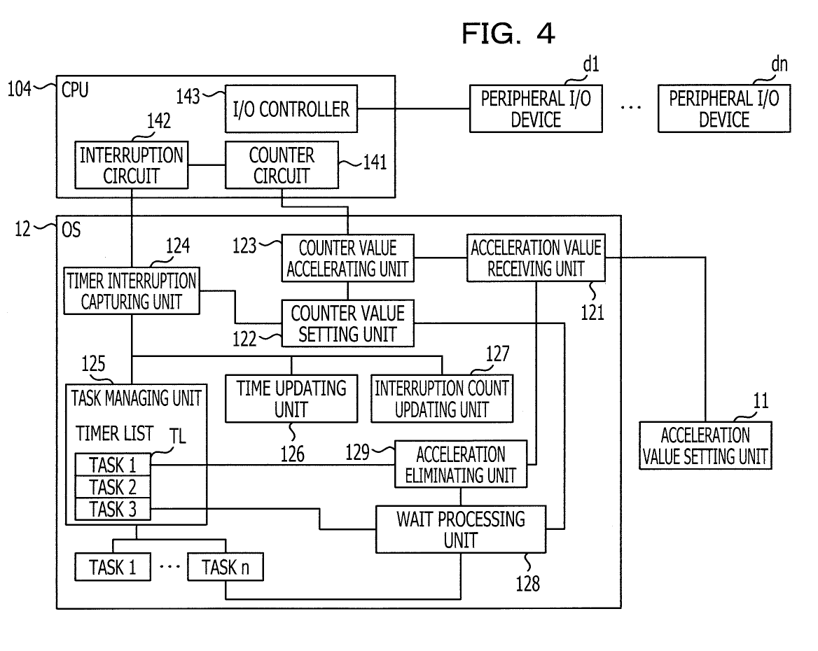

FIG. 4 is a diagram illustrating an example of a function configuration of a test device according to a first embodiment. FIG. 4 illustrates the CPU 104, an acceleration value setting unit 11, an Operating System (OS) 12, and the like.

The CPU 104 includes a counter circuit 141, an interruption circuit 142, an I/O controller 143, and the like. The counter circuit 141 decrements the counter value set by the counter value accelerating unit 123 in a period based on a prescribed frequency (hereinafter, referred to as “counter frequency”). If the counter value indicates 0, the counter circuit 141 reports the counter value to the interruption circuit 142. That is, the counter circuit 141 detects a generation time of the timer interruption by using the counter value. Hereinafter, the “counter value” is referred to as a counter value that is used by the counter circuit 141.

In response to the report from the counter circuit 141, the interruption circuit 142 generates timer interruption.

The I/O controller 143 controls input and output of data to and from peripheral I/O devices d1 to dn (hereinafter referred to as “peripheral I/O device d” if the peripheral I/O devices d1 to dn are not distinguished from each other). According to the embodiment, the peripheral I/O device d is an example of hardware operating asynchronously with the timer interruption or the timer interruption period. As illustrated in FIG. 3, the auxiliary storage device 102, the memory device 103, the drive device 100, and the like are given as examples of the peripheral I/O device d. The peripheral I/O device d may be a device outside the test device 10 such as an external storage medium.

The acceleration value setting unit 11 sets a coefficient (hereinafter referred to as “acceleration value”) that reduces the timer interruption period to the OS12. The acceleration value is larger than 0 and equal to or smaller than 1. If the acceleration value is 1, the timer interruption period is not reduced. The acceleration value setting unit 11 displays, for example, a Graphical User Interface (GUI) to obtain the acceleration value. Furthermore, the acceleration value setting unit 11 may obtain the acceleration value to be stored in the auxiliary storage device 102 through the GUI. The acceleration value setting unit 11 is achieved by the processing to be performed by the CPU 104 by the program installed into the test device 10.

The OS12 is installed into the test device 10. As illustrated in FIG. 4, the OS12 includes an acceleration value receiving unit 121, a counter value setting unit 122, a counter value accelerating unit 123, a timer interruption capturing unit 124, a task managing unit 125, a time updating unit 126, an interruption count updating unit 127, and a wait processing unit 128, an acceleration eliminating unit 129, and the like. Each of the units is achieved by the processing, which is to be performed by the program included in the OS12, by the CPU 104 of the test device 10.

The acceleration value receiving unit 121 receives the acceleration value from the acceleration value setting unit 11. The acceleration value receiving unit 121 reports the received acceleration value to the counter value accelerating unit 123 and the acceleration eliminating unit 129. The counter value setting unit 122 sets the counter value to the counter value accelerating unit 123 every time the timer interruption is generated. Every time the counter value is set by the counter value setting unit 122, the counter value accelerating unit 123 sets the value (the counter value), which is obtained by multiplying the counter value by the acceleration value reported from the acceleration value receiving unit 121, to the counter circuit 141. Therefore, if the acceleration value is larger than 0 and smaller than 1, the counter value is smaller than the original value that the counter value setting unit 122 has. As a result, the timer interruption period is reduced.

The timer interruption capturing unit 124 functions as a so-called interruption handler. That is, the timer interruption capturing unit 124 captures or detects the timer interruption generated by the CPU 104. According to the captured timer interruption, the timer interruption capturing unit 124 calls, for example, the counter value setting unit 122, the task managing unit 125, the time updating unit 126, the interruption count updating unit 127, and the like.

In response to the wait request from the task, the wait processing unit 128 performs for making the task wait for the wait time specified by the wait request. The task indicates a performance unit of the processing managed by the OS12. For example, a thread or a process is an example of the performance unit of the processing.

Regarding the wait time of the task, the wait processing unit 128 converts the value in the second unit into a value (hereinafter, referred to as “periodicity”) in a generation period unit of the timer interruption. Specifically, to transmit the wait request to the OS12, the task specifies the wait time according to the value in the second unit. The wait processing unit 128 converts the wait time into a periodicity by dividing the value in the second unit by the timer interruption period. The wait processing unit 128 reports the periodicity of the conversion result to the acceleration eliminating unit 129 or the task managing unit 125. For example, if the task related to the wait request performs the I/O processing, the periodicity is reported to the acceleration eliminating unit 129. On the other hand, if the task related to the wait request does not perform the I/O processing (for example, the task operated simply by the CPU 104), the periodicity is directly reported to the task managing unit 125. In this case, the word “directly” means that the periodicity is reported without going through the acceleration eliminating unit 129. Furthermore, the I/O processing transmits a processing request to the peripheral I/O device d and waits for a reply corresponding to the processing request.

Regarding the wait time of the task performing the I/O processing, the acceleration eliminating unit 129 eliminates the acceleration based on the acceleration value. Specifically, the acceleration eliminating unit 129 corrects the periodicity reported from the wait processing unit 128 by dividing the periodicity by the acceleration value. The acceleration eliminating unit 129 reports the corrected periodic number (hereinafter referred to as “correction periodicity” to the task managing unit 125. The acceleration value is obtained by the acceleration value receiving unit 121, for example.

The task managing unit 125 performs scheduling or the like of the task operating on the OS12. The task managing unit 125 includes a timer list TL. The timer list TL is schedule information of each task. For example, the timer list TL records the time at which each task is operated.

The time updating unit 126 updates the time information managed by the OS12. The interruption count updating unit 127 updates the value of the variable that holds the interruption count.

As described above, the task managing unit 125 and the time updating unit 126 are called by the timer interruption capturing unit 124. That is, the task managing unit 125 and the time updating unit 126 perform the processing at the time of generation of the timer interruption. Therefore, if the timer interruption period is accelerated, the processing period of the task managing unit 125 and the time updating unit 12 is accelerated. As a result, the time related to the task management is accelerated (reduced) or the time elapse is accelerated.

For example, the task managing unit 125 detects the wake up time of the waiting task by using the periodicity reported from the wait processing unit 128 or the correction periodicity reported from the acceleration eliminating unit 129. That is, the task managing unit 125 detects the expiration of the wait time when the timer interruption after the wait start is generated for the count indicated by the periodicity or the correction periodicity. In other words, when the timer interruption for the count indicated by the periodicity or the correction periodicity is generated, the task managing unit 125 measures the wait time. Therefore, the wait time is measured based on the correction periodicity reported from the acceleration eliminating unit 129, the wait time is accelerated. That is, the wait time is shorter than the real time specified by the task. On the other hand, if the wait time is measured based on the periodicity reported from the wait processing unit 128, the wait time is not accelerated. That is, the wait time is equivalent to the real time specified by the task.

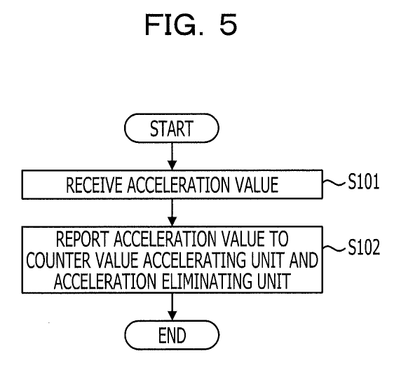

A processing procedure in the test device 10 will be described below. FIG. 5 is a flowchart illustrating an example of a processing procedure performed by the acceleration value receiving unit.

In Operation S101, the acceleration value receiving unit 121 receives the acceleration value from the acceleration value setting unit 11. The acceleration value receiving unit 121 reports the received acceleration value to the counter value accelerating unit 123 and the acceleration eliminating unit 129, respectively (Operation S102).

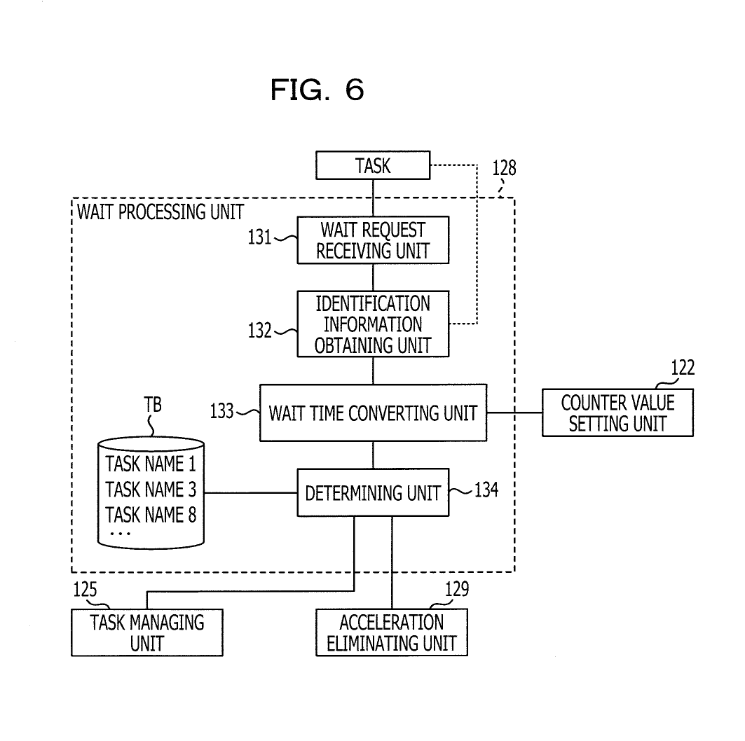

The wait processing unit 128 will be described. FIG. 6 is a diagram illustrating an example of a function configuration of a wait processing unit according to the first embodiment. As illustrated in FIG. 6, the wait processing unit 128 includes a wait request receiving unit 131, an identification information obtaining unit 132, a wait time converting unit 133, a determining unit 134, and the like.

The wait request receiving unit 131 receives a wait request from the task. The wait request is received in such a way that, for example, a wait function is an interface. The identification information obtaining unit 132 obtains the identification information used to identify or determine whether or not the task related to the wait request (hereinafter, referred to as “wait task”) is a task that performs the I/O processing. According to the first embodiment, a task name is used as the identification information. The task name is, for example, a program file name related to a task. Therefore, the identification information obtaining unit 132 obtains the task name based on the wait task. The wait processing unit 128 performs the processing inside a process space that is substantially same as the process space of each task. Accordingly, the identification information obtaining unit 132 may easily obtain the task name of the wait task.

The wait time converting unit 133 converts the wait time in the second unit, which is specified by the wait request, into a periodicity. Regarding the wait time of the wait task, the determining unit 134 determines whether or not correction (elimination of the acceleration) by the acceleration eliminating unit 129 is desired. Specifically, based on the identification information obtained by the identification information obtaining unit 132, the determining unit 134 determines whether or not the wait task performs the I/O processing. According to the first embodiment, depending on whether the task name as the identification information is included in an I/O processing identification table TB, the determining unit determines whether or not the wait task performs the I/O processing. According to the determination result, the determining unit 134 reports the periodicity to the task managing unit 125 or the acceleration eliminating unit 129.

The I/O processing identification table TB records a list of the task names of the tasks performing the I/O processing. The I/O processing identification table TB is recorded in, for example, a memory such as the auxiliary storage device 102.

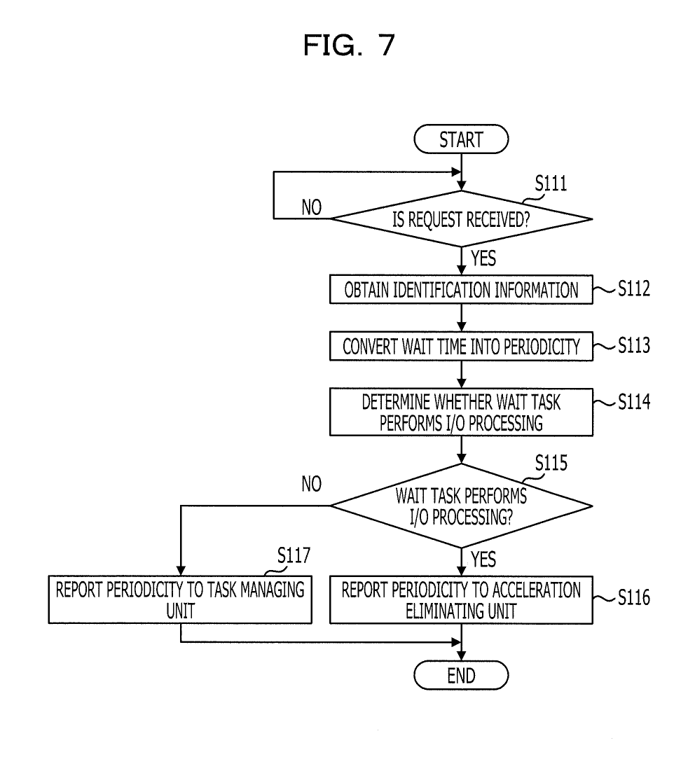

The processing procedure of the wait processing unit 128 will be described below. FIG. 7 is a flowchart illustrating an example of a processing procedure performed by the wait processing unit according to the first embodiment.

If the wait request receiving unit 131 receives the wait request based on the task (the wait task) (Yes in Operation S111), the identification information obtaining unit 132 obtains the task name of the wait task (Operation S112). The wait time converting unit 133 converts the wait time in the second unit specified by the wait request into a periodicity by dividing the wait time by the timer interruption period (Operation S113).

Depending on whether the task name of the wait task is included in the I/O processing identification table TB, the determining unit 134 determines whether or not the wait task performs the I/O processing (Operation S114). If the task name is included in the I/O processing identification table TB, that is, if the wait task performs the I/O processing (Yes in Operation S115), the determining unit 134 reports the periodicity to the acceleration eliminating unit 129 (Operation S116). On the other hand, if the task name is not included in the I/O processing identification table TB, that is, if the wait task does not perform the I/O processing (No in Operation S115), the determining unit 134 reports the periodicity to the task managing unit 125 (Operation S117). Based on the periodicity, the task managing unit 125 registers the wake up time of the wait task in the timer list TL.

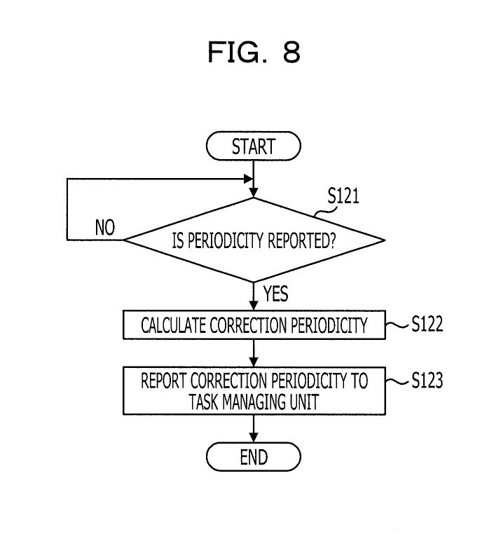

The processing procedure of the acceleration eliminating unit 129 will be described below. FIG. 8 is a flowchart illustrating an example of the processing procedure performed by the acceleration eliminating unit.

If the periodicity is reported from the wait processing unit 128 (Yes in Operation S121), the acceleration eliminating unit 129 calculates a correction periodicity by dividing the periodicity by the acceleration value (Operation S122). The acceleration value is reported from the acceleration value receiving unit 121 in Operation S102 illustrated in FIG. 5. The acceleration eliminating unit 129 reports the correction periodicity to the task managing unit 125 (Operation S123). Based on the correction periodicity, the task managing unit 125 registers the wake up time of the wait task in the timer list TL.

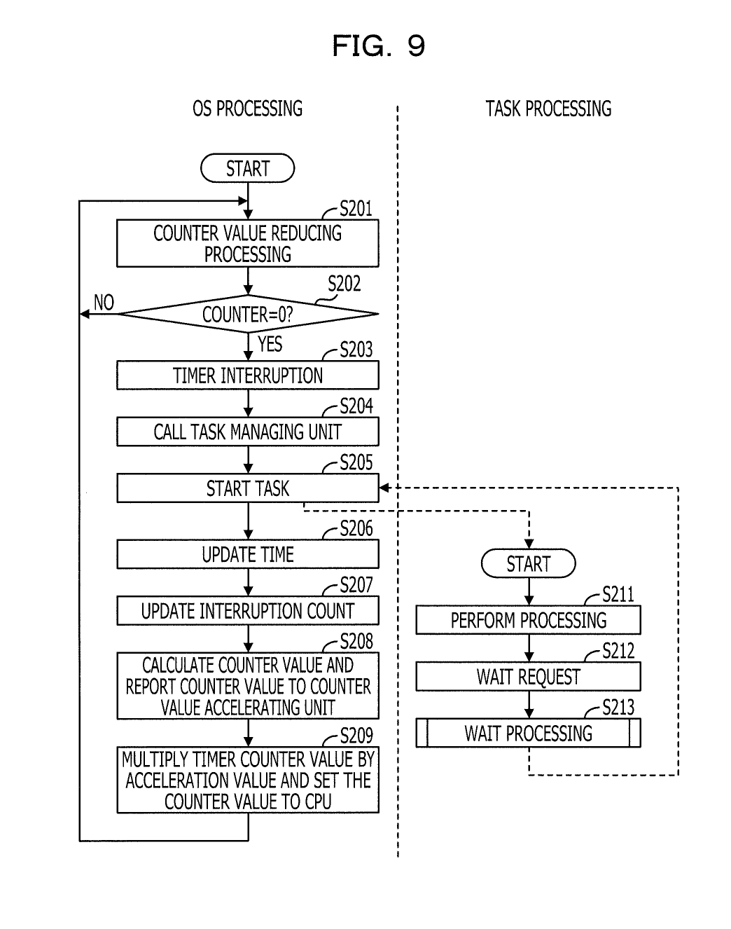

The entire processing procedure performed by the units illustrated in FIG. 4 will be described below. FIG. 9 is a flowchart illustrating an example of the processing procedure of the whole test device.

The counter circuit 141 reduces the counter value set by the counter value accelerating unit 123 by the period based on the counter frequency (Operations S201 and S202). If the counter value indicates 0, the interruption circuit 142 generates timer interruption (Operation S203).

The timer interruption is captured by the timer interruption capturing unit 124. When the timer interruption is captured, the interruption circuit 142 calls the task managing unit 125, the time updating unit 126, the interruption count updating unit 127, the counter value setting unit 122, and the like (Operation S204).

In response to the call from the timer interruption capturing unit 124, the task managing unit 125 starts or wakes up the task at the start time or the wake up time (Operation S205). In response to the call from the timer interruption capturing unit 124, the time updating unit 126 updates the time information that is managed by the OS12 (Operation S206). In response to the call from the timer interruption capturing unit 124, the interruption count updating unit 127 adds 1 to the value of the variable that holds the interruption count (Operation S207).

In response to the call from the timer interruption capturing unit 124, the counter value setting unit 122 calculates the counter value. The counter value is calculated by dividing the counter frequency by the timer interruption frequency (the reverse of the timer interruption period), which is reported at the time of the call from the timer interruption capturing unit 124. The counter value setting unit 122 reports the calculated counter value to the counter value accelerating unit 123 (Operation S208). The counter value accelerating unit 123 calculates the accelerated counter value by multiplying the reported counter value by the acceleration value reported from the acceleration value receiving unit 121. The counter value accelerating unit 123 sets the calculated counter value to the counter circuit 141 (Operation S209).

On the other hand, the task operated in Operation S205 performs prescribed processing (Operation S211). For example, the task transmits the processing request to the peripheral I/O device d. To wait for a reply with respect to the processing request, the task specifies the wait time to input the wait request into the wait processing unit 128 (Operation S212). In the task (for example, in the process space related to the task), the wait processing unit 128 performs wait processing illustrated in FIG. 7 (Operation S213). The task name of the task is registered in the I/O processing identification table TB to perform the I/O processing. The correction periodicity (that is, the periodicity of which the acceleration is eliminated) is reported to the task managing unit 125. As a result, the task is waked up after the generation of the timer interruption of the count indicated by the correction periodicity, that is, after the time elapse in the second unit specified by the wait request.

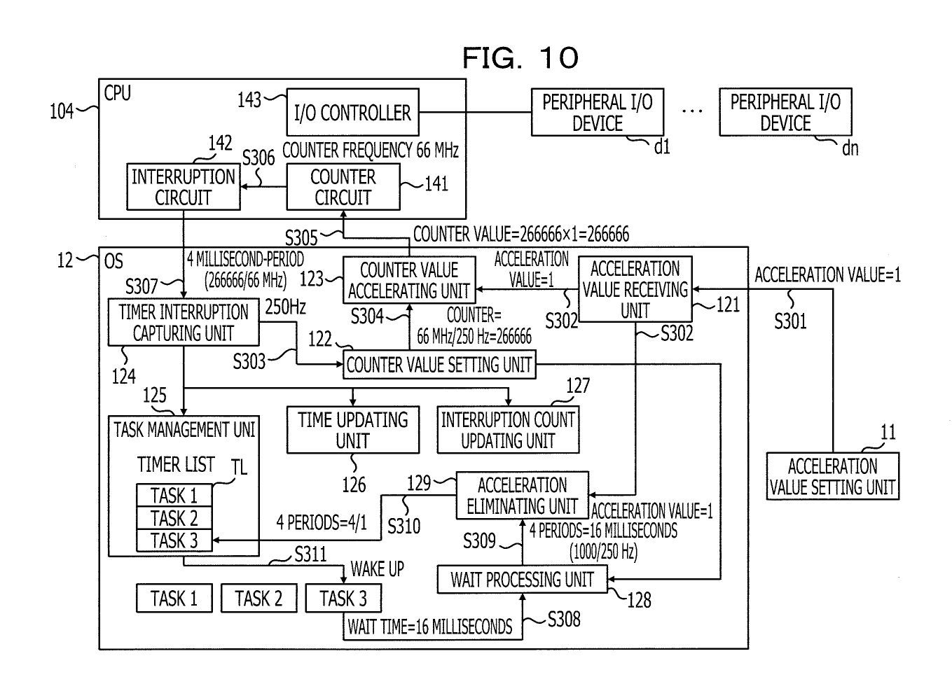

An operation example of the test device 10 will be described by using a specific value in each parameter. FIG. 10 is a diagram illustrating a specific example of the operation of the test device when the timer interruption period is not accelerated. In FIG. 10, the counter frequency is 66 MHz, and the timer interruption frequency is 250 Hz (that is, the timer interruption period is 4 milliseconds).

In Operation S301, the acceleration value receiving unit 121 receives “1” as the acceleration value to be set from the acceleration value setting unit 11. That is, the timer interruption period is set not to be accelerated. The acceleration value receiving unit 121 reports “1” as the acceleration value to the counter value accelerating unit 123 and the acceleration eliminating unit 129 (Operation S302).

To generate the timer interruption in the period of 4 milliseconds, the timer interruption capturing unit 124 sets 250 Hz that is the reverse of 4 milliseconds as the timer interruption frequency to the counter value setting unit 122 (Operation S303). By dividing the counter frequency by the timer interruption frequency (250 Hz), the counter value setting unit 122 calculates the counter value (266666) and sets the counter value to the counter value accelerating unit 123 (Operation S304).

The counter value accelerating unit 123 sets the value (266666×1=266666) obtained by multiplying the counter value by the acceleration value as the counter value to the counter circuit 141 (Operation S305). The counter circuit 141 decrements the counter value (266666) in the period of 1000/66 MHz and reports the counter value to the interruption circuit 142 when the counter indicates 0 (Operation S306). In response to the report from the counter circuit 141, the interruption circuit 142 generates the timer interruption (Operation S307). In response to the generation of the timer interruption, the timer interruption capturing unit 124 performs Operation S303. That is, Operation after Operation S303 is repeated in response to the generation of the timer interruption. As a result, the timer interruption is generated in the period of 266666/66 MHz=4 milliseconds.

In this state, the tasks 1, 2, and 3 are operated on the OS12, and the task 3 performs the I/O processing. That is, the task name of the task 3 is registered in the I/O processing identification table TB.

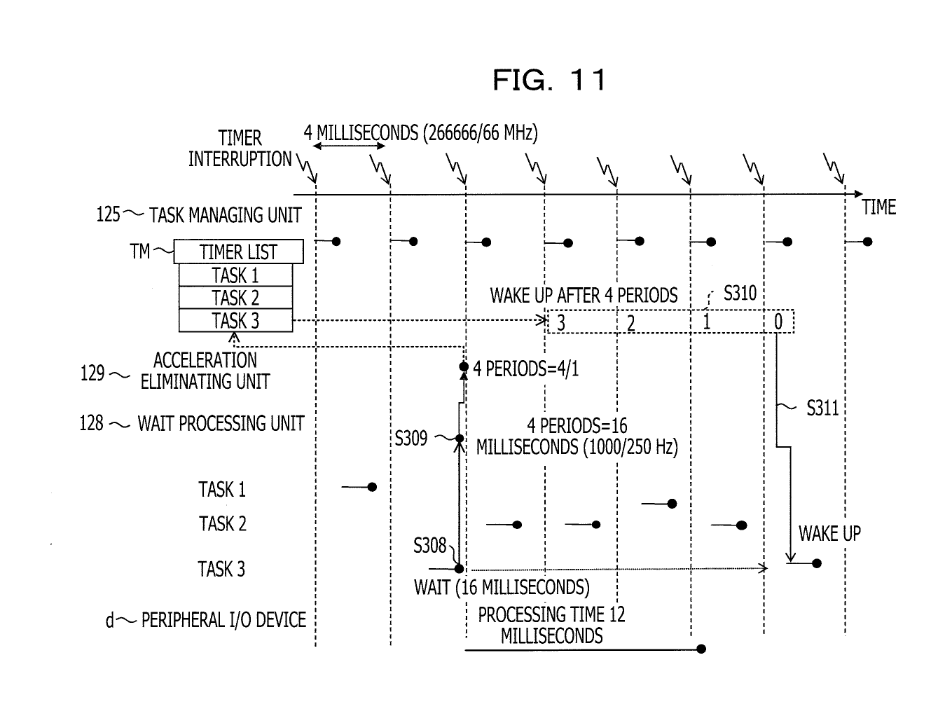

With reference to FIG. 11 as well as FIG. 10, embodiments will be described below. FIG. 11 is a diagram illustrating an example of a relation between a task operation and a time in a test device when the timer interruption period is not accelerated. FIG. 11 indicates a performance timing of processing for each performance subject of the processing. That is, the horizontal direction illustrated in FIG. 11 indicates the time axis. On the other hand, in the vertical direction, the task managing unit 125, the acceleration eliminating unit 129, the wait processing unit 128, the task 1, the task 2, the task 3, the peripheral hardware d, and the like are allocated as the performance subject of the processing.

After transmitting the processing request to the peripheral I/O device d, the task 3 specifies the wait time of 16 milliseconds and transmits the wait request to the wait processing unit 128 (Operation S308). The wait processing unit 128 obtains the timer interruption frequency (250 Hz) from the counter value setting unit 122 and converts the wait time (16 milliseconds) specified by the wait request into a periodicity. The periodicity is calculated by dividing the wait time (16 milliseconds) by the timer interruption period (1000/250 Hz). Therefore, 16 milliseconds/(1000/250 Hz)=4 periods is the periodicity. The task name of the task 3 is registered in the I/O processing identification table TB. Accordingly, the wait processing unit 128 reports the periodicity to the acceleration eliminating unit 129 (Operation S309).

The acceleration eliminating unit 129 calculates the correction periodicity by dividing the periodicity by the acceleration value reported from the acceleration value receiving unit 121. Therefore, the correction periodicity is 4/1=4 periods. The acceleration eliminating unit 129 reports the correction periodicity to the task managing unit 125 (Operation S310). The task managing unit 125 wakes up the task 3 after the timer interruption for the reported correction periodicity is generated (Operation S311). In this case, the timer interruption period is 4 milliseconds. Therefore, after 4×4=16 milliseconds, the task 3 is waked up. That is, the task is waked up according to the wait time specified in the wait request by the task 3. On the other hand, the processing time of the peripheral I/O device d is 12 milliseconds. Therefore, after the task 3 is waked up, the task 3 may obtain the reply from the peripheral I/O device d to continue the processing.

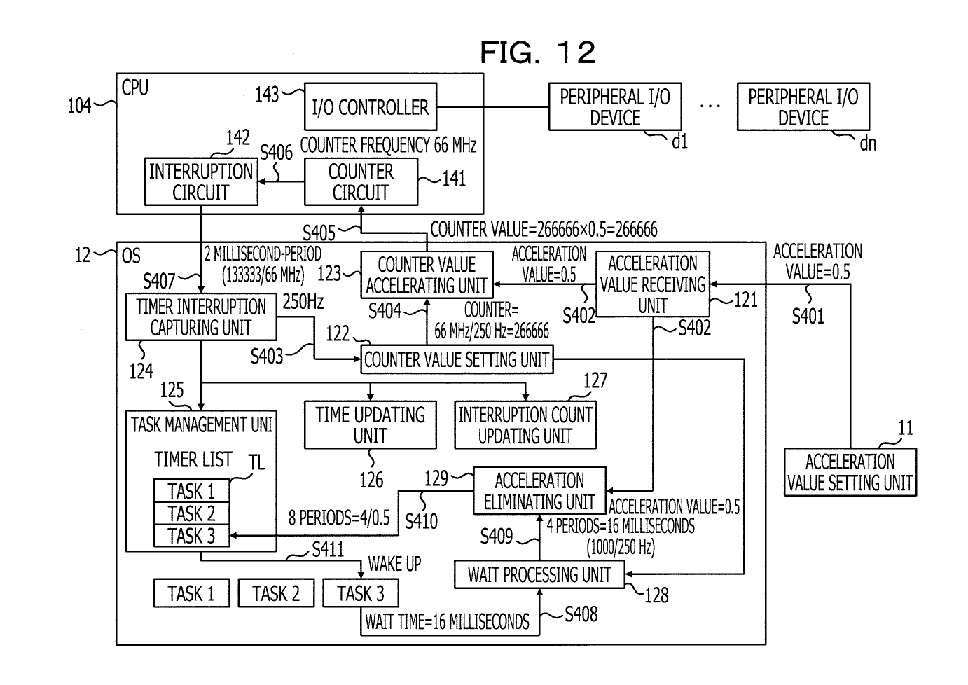

A case where the timer interruption period is accelerated by half will be described below. FIG. 12 is a diagram illustrating a specific example of an operation of a test device when the timer interruption period is accelerated by half. In FIG. 12, the counter frequency is 66 MHz. The timer interruption frequency is 250 Hz (that is, the timer interruption period is 4 milliseconds).

In Operation S401, the acceleration value receiving unit 121 receives “0.5” as the acceleration value from the acceleration value setting unit 11. That is, the timer interruption period is set to be accelerated by half. The acceleration value receiving unit 121 reports “0.5” as the acceleration value to the counter value accelerating unit 123 and the acceleration eliminating unit 129 (Operation S402).

To generate the timer interruption in the period of 4 milliseconds, the timer interruption capturing unit 124 sets 250 Hz as the reverse of 4 milliseconds as the timer interruption frequency to the counter value setting unit 122 (Operation S403). By dividing the counter frequency (66 MHz) by the timer interruption frequency (250 Hz), the counter value setting unit 122 calculates the counter value (266666) and sets the counter value to the counter value accelerating unit 123 (Operation S404).

The counter value accelerating unit 123 sets the value (266666×0.5=133333), which is obtained by multiplying the counter value by the acceleration value, as the counter value to the counter circuit 141 (Operation S405). The counter circuit 141 decrements the counter value (133333) in the period of 1000/66 MHz and reports the counter value to the interruption circuit 142 when the counter indicates 0 (Operation S406). In response to the report from the counter circuit 141, the interruption circuit 142 generates the timer interruption (Operation S407). In response to the generation of the timer interruption, the timer interruption capturing unit 124 performs Operation S403. That is, Operation after Operation S403 is repeated in response to the generation of the timer interruption. As a result, the timer interruption is generated in the period of 133333/66 MHz=2 milliseconds.

In this state, the tasks 1, 2, and 3 are operated on the OS12, and the task 3 performs the I/O processing. That is, the task name of the task 3 is registered in the I/O processing identification table TB.

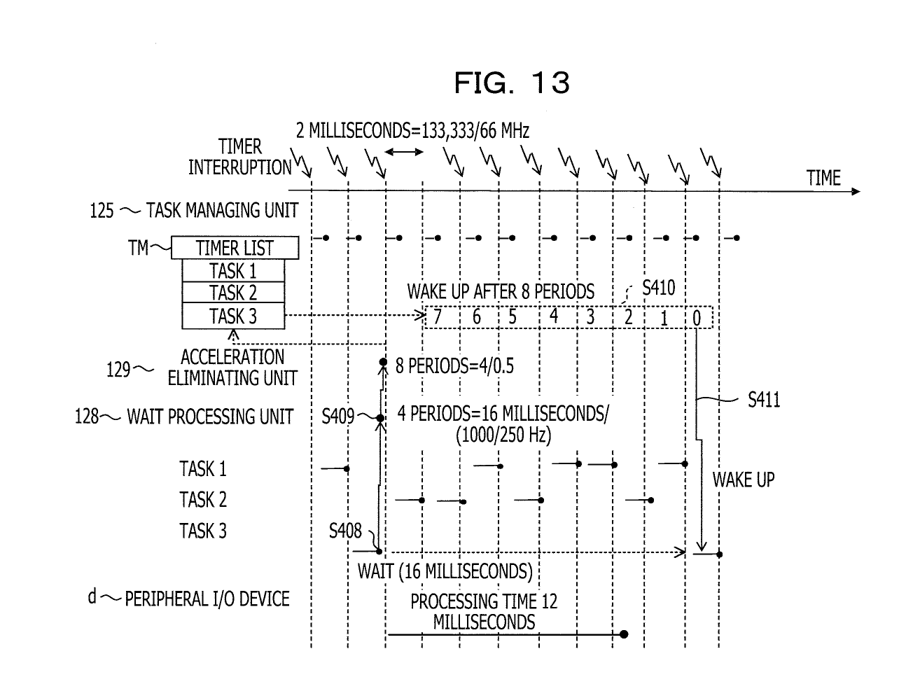

With reference to FIG. 13 as well as FIG. 12, embodiments will be described below. FIG. 13 is a diagram illustrating an example of a relation between the task operation and the time in the test device when the timer interruption period is accelerated by half. The perspective of FIG. 13 is equivalent to FIG. 11.

After transmitting the processing request to the peripheral I/O device d, the task 3 specifies the wait time of 16 milliseconds and transmits the wait request to the wait processing unit 128 (Operation S408). The wait processing unit 128 obtains the timer interruption frequency (250 Hz) from the counter value setting unit 122 and converts the wait time (16 milliseconds) specified by the wait request into a periodicity. The periodicity is calculated by dividing the wait time (16 milliseconds) by the timer interruption period (1000/250 Hz). Therefore, 16 milliseconds/(1000/250 Hz)=4 periods is the periodicity. The task name of the task 3 is registered in the I/O processing identification table TB. Therefore, the wait processing unit 128 reports the periodicity to the acceleration eliminating unit 129 (Operation S409).

The acceleration eliminating unit 129 calculates the correction periodicity by dividing the periodicity by the acceleration value reported from the acceleration value receiving unit 121. Therefore, the correction periodicity is 4/0.5=8 periods. The acceleration eliminating unit 129 reports the correction periodicity to the task managing unit 125 (Operation S410). The task managing unit 125 wakes up the task 3 after the timer interruption for the reported correction periodicity is generated (Operation S411). In this case, the timer interruption period is 2 milliseconds. Therefore, the task is waked up after 2×8=16 milliseconds. That is, the task 3 is waked up on the wait time specified by the task 3 in the wait request. On the other hand, the processing time of the peripheral I/O device d is 12 milliseconds. Therefore, after being waked up, the task 3 may obtain the reply from the peripheral I/O device d and continue the processing.

As described above, according to the first embodiment, while the timer interruption period is accelerated (or shortened), the acceleration may be eliminated regarding the wait time of the reply from the hardware operating asynchronously with the period. That is, the wait time may be returned to the real time. Therefore, the acceleration test of the whole software, which includes the I/O processing related to the hardware operating asynchronously with the timer interruption period, may be performed.

As a result, for example, overflow or underflow of the variable that is incremented or decremented in a prescribed period may be detected in a short time. The time desired for confirmation of a long-term operation stability of software may be reduced. Based on the timer or the like, regarding the software operating in schedule of the date and time determined in advance or the device controlled by the software, the desired time of the test may be reduced without changing the content of the schedule.

The object that is operating asynchronously with the timer interruption period is not limited to the hardware. For example, software operating on a computer coupled with the test device 10 through a network is applicable. That is, the task operating in the test device 10 performs the processing request on the software, and the acceleration may be eliminated when the task waits for the reply based on the processing request.

A second embodiment will be described below. The second embodiment is different from the first embodiment in that part of the processing content performed by the wait processing unit 128 is different.

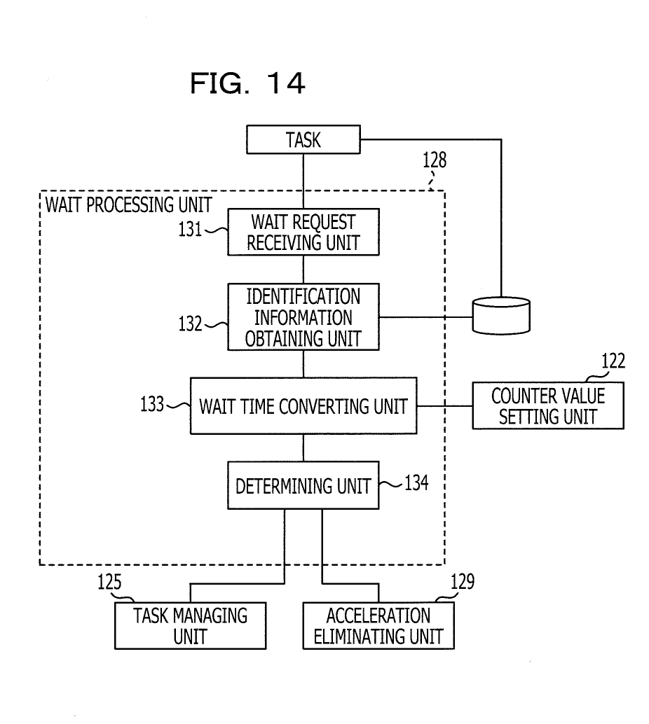

FIG. 14 is a diagram illustrating an example of a function configuration of a wait processing unit according to the second embodiment. In FIG. 14, the parts equivalent to FIG. 6 are indicated with the similar numerals, so that the description is omitted.

According to the second embodiment, the wait task performing the I/O processing records the flag information indicating whether or not the wait for the I/O processing in the memory device 103, for example.

The identification information obtaining unit 132 of the wait processing unit 128 obtains the flag information from the memory device 103. Based on the flag information, the determining unit 134 determines whether or not the wait task is for the I/O processing. According to the determination result, the determining unit 134 reports the periodicity to the task managing unit 125 or the acceleration eliminating unit 129.

As described above, the method for determining whether or not the task related to the wait request is for the I/O processing is not limited to a prescribed method. For example, an Application Program Interface (API) that receives the wait request that is for the I/O processing may be clearly distinguished from the wait request that is not for the I/O processing. The task related to the wait request monitors a virtual address to be accessed. If the virtual address corresponds to a memory mapped I/O area of the peripheral I/O device d, the wait request by the task may be determined to be related to the wait for the I/O processing. That is, based on any identification information related to the wait request, the wait may be determined to be for the I/O processing.

A third embodiment will be described. The third embodiment will describe a case where the acceleration test is automatically started at the actual date specified in advance and where the acceleration test is ended at the actual date specified in advance.

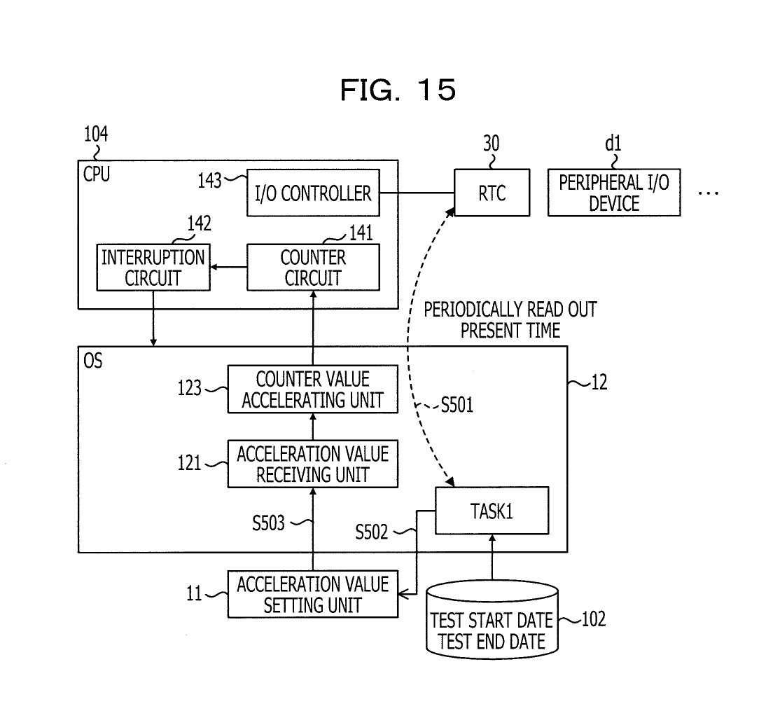

FIG. 15 is a diagram illustrating the third embodiment. In FIG. 15, the parts equivalent to FIG. 4 are indicated with the similar numerals, so that the description is omitted. In FIG. 15, some of the configuration elements of the OS12 are omitted for convenience sake.

In FIG. 15, the task 1 is a resident program that periodically reads out a Real Time Clock (RTC) 30. For example, the auxiliary storage device 102 records a test start date and a test end date in advance. The RTC 30 updates the time by power supply from an internal battery even though the power is turned off, and the RTC 30 is generally used in an information processing device.

The task 1 periodically compares the time information read out from the RTC 30 to the test start date. When the task 1 detects the arrival of the test start time, the task 1 sets the acceleration value, which is larger than 0 and smaller than 1, to the acceleration value setting unit 11. The acceleration value setting unit 11 sets the acceleration value to the acceleration value receiving unit 121 (Operation S503). As a result, the timer interruption period is accelerated, and the acceleration test is performed.

On the other hand, even during the acceleration test, the task 1 periodically compares the time information read out from the RTC 30 to the test end date. When the task 1 detects the arrival of the test end date, the task 1 sets “1” as an acceleration value to the acceleration value setting unit 11. As a result, the acceleration test ends.

During the acceleration test, even when the task 1 performs the accelerated operation (for example, reduction or the like of reading out period of the time information of the RTC 3 is generated), the time information read out from the RTC 30 indicates the real time. Therefore, the acceleration test may be ended on the actual date specified as the test end date.

When the acceleration test is performed, the time information of the OS 12 is accelerated. Thus, the present time is difficult to be obtained. According to the third embodiment, the actual time may be obtained even by the task that is in the acceleration operation.

A fourth embodiment will be described below. In the fourth embodiment, based on a prescribed sequence, an example of a case where the test device 10 controls the external tested device will be described.

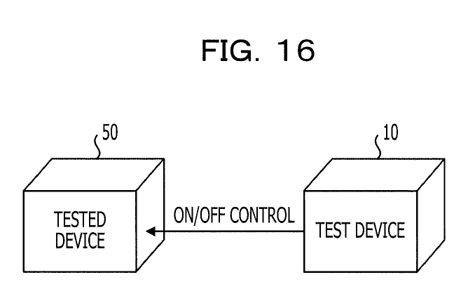

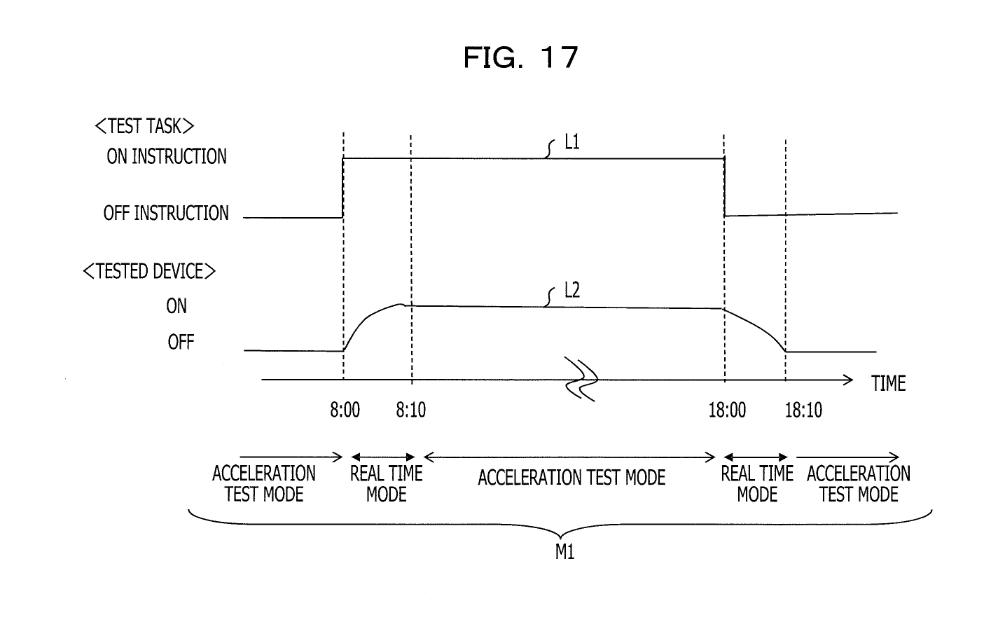

FIG. 16 is a diagram illustrating the fourth embodiment. In FIG. 16, the test device 10 is coupled with the tested device 50 through a network such as a Local Area Network (LAN), for example. The hardware configuration and the function configuration of the test device 10 are illustrated in FIG. 3 and FIG. 4. The task (hereinafter referred to as “test task”) operating on the test device 10 repeatedly performs the ON/OFF control of the tested device 50 in a schedule that is set in advance. In this case, the schedule is processed early by setting the acceleration value that is larger than 0 and smaller than 1 to the OS12 of the test device 10. The tested device 50 typically takes a certain time until the power is turned OFF after the instruction of power OFF is received. Furthermore, the tested device 50 takes a while to be in a steady state after receiving the instruction of power ON. Therefore, the test task is desired to perform the control in consideration of the time desired when the tested device 50 turns on the power or turns off the power. Regarding the schedule information, even if the schedule is set in consideration of the desired time, the time is accelerated during the acceleration test. The test device 10 operates the test task as illustrated in FIG. 17.

FIG. 17 is a diagram illustrating an operation example of the test task and the tested device according to the fourth embodiment.

In FIG. 17, the line indicated with a L1 indicates the ON/OFF control of the test task. On the other hand, the line indicated with a L2 indicates the ON/OFF operation of the tested device 50 according to the ON/OFF instruction of the test task. The part with M1 indicates the operation state (an acceleration test mode or a real time mode) of the test device 10. The acceleration test mode indicates a state where the acceleration value that is larger than 0 and smaller than 1 to the OS12, that is, a state where the timer interruption period is accelerated. The real time mode indicates a state where 1 is set as an acceleration value to the OS12, that is, a state where the timer interruption period is not accelerated. The time added to the horizontal axis is a time indicated in the time information managed by the OS12 of the test device 10.

For example, based on the schedule information, the test task transmits the instruction of power ON at 8:00 and sets “1” as an acceleration value to the acceleration value setting unit 11. As a result, the test device 10 is in the real time mode. Accordingly, the test task waits at the real time until 8:10, which is specified in the schedule information, as the control start time of the tested device 50.

On the other hand, after receiving the instruction of power ON, the tested device 50 turns on the power. After turning on the power, the tested device 50 takes less than 10 minutes to be in the steady state.

At 8:10, the test task sets the acceleration value, which is larger than 0 and smaller than 1, to the acceleration value setting unit 11 and remotely performs various control on the tested device 50. Therefore, the control is performed in the acceleration test mode.

After that, at 18:00 as the time of power OFF specified in the schedule information, the test task sets “1” as an acceleration value to the acceleration value setting unit 11 with respect to the tested device 50. As a result, the test device 10 is in the real time mode. Therefore, the test task waits at the real time specified in the schedule information until 18:10 as the control start time of the tested device 50.

On the other hand, when receiving the instruction of power OFF, the tested device 50 turns off the power. After the power is turned off, the tested device 50 takes less than 10 minutes to be in the power OFF state.

At 18:10, the test task sets the acceleration value, which is larger than 0 and smaller than 1, to the acceleration value setting unit 11, and, for example, checks if the power is turned off regarding the tested device 50. Therefore, the confirmation and the like are performed in the acceleration test mode.

As described above, by properly switching the acceleration test mode from or to the real time mode, the time desired for the whole test may be reduced while the time is synchronized with the desired time in the power ON state or the power OFF state of the tested device 50.

According to the fourth embodiment, the power ON/OFF control of the tested device 50 is described as an example. However, apart from the power ON/OFF control, the acceleration test mode may be switched to the real time mode if the elapse time is desired to be matched between the test device 10 and the tested device 50.

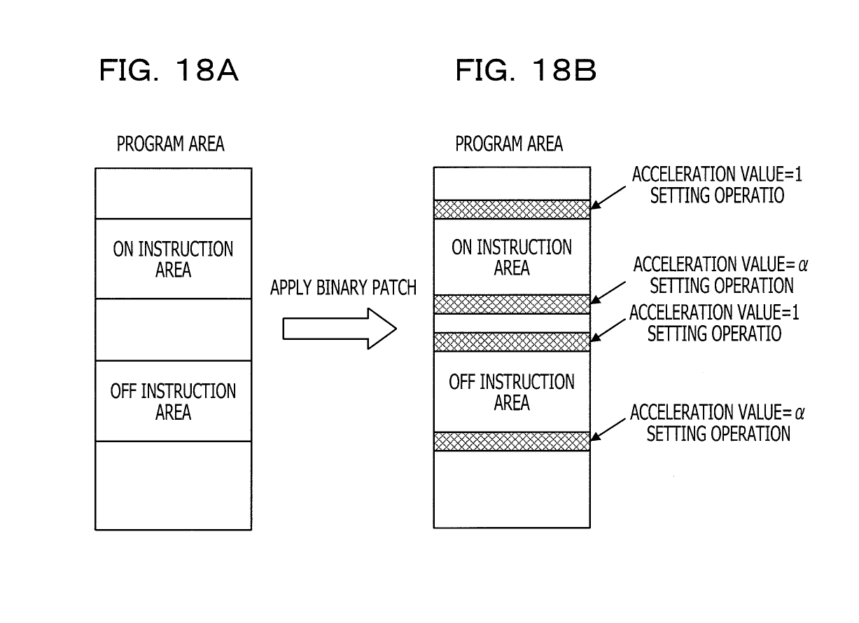

If the program related to the test task of the fourth embodiment is implemented without the acceleration test, that is, if the setting processing of the acceleration value for the acceleration value setting unit 11 is not mounted on the program, the program may be deformed as illustrated in FIG. 18.

FIGS. 18A and 18B are diagrams illustrating a deformation example of the program related to the test task according to the fourth embodiment. FIG. 18A indicates the program area that is not yet deformed. The program area includes an area where the power ON instruction is performed (ON instruction area) and an area where the power OFF instruction is performed.

With respect to the program area, by applying a binary patch for adding a setting operation of an acceleration value before and after the ON instruction area and the OFF instruction area, the program area may be deformed as illustrated in FIG. 18B.

FIG. 18B includes an operation for setting “1” as an acceleration value before the ON instruction area or the OFF instruction area. FIG. 18B further includes an operation for setting 0≦α≦1 as an acceleration value after the ON instruction area or the OFF instruction area. By having the program area illustrated in FIG. 18B, the test task may perform the control illustrated in FIG. 17.

According to the fourth embodiment, the counter value accelerating unit 123 is an example of a reducing unit. The acceleration eliminating unit 129 is an example of a correcting unit. The task managing unit 125 is an example of a measuring unit.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has (have) been described in detail, it should be understood that the various changes, substitutions, and alterations could be made hereto without departing from the spirit and scope of the invention.

What is claimed is:

1. A test method which is performed by a computer, the test method comprising:
reducing a first period of timer interruption to a second period by multiplying the first period by a prescribed coefficient;
converting, by using the computer, a wait time of a task, which waits for processing operating asynchronously with the timer interruption, into a first periodicity which is obtained by dividing the second period;
obtaining a second periodicity by dividing the first periodicity by the prescribed coefficient; and
determining the timer interruption on the basis of the second periodicity.

2. The test method which is performed by the computer according to claim 1, further comprising:
when a wait request is received from the task, referring to a memory which stores a piece of identification information related to the task which waits for the processing operating asynchronously with the timer interruption; and
determining whether or not the periodicity is typically corrected regarding the task related to the wait request.

3. The test method which is performed by the computer according to claim 2, wherein the determining whether or not the periodicity is typically corrected includes determining that the periodicity is typically corrected when the received identification information of the task related to the wait request and when the obtained identification information of the task related to the wait request is stored in the memory.

4. The test method which is performed by the computer according to claim 1, further comprising:
periodically reading out a piece of time information from a Real Time Clock (RTC),
comparing the read time information to a piece of test start time information stored in the memory; and
reducing the first period to the second period when the read time information matches the test start time information.

5. The test method which is performed by the computer according to claim 1, wherein the prescribed coefficient is larger than 0 and equal to or smaller than 1.

6. A non-transitory recording medium recording a test program, the test program causing a computer to execute procedures comprising:
reducing a first period of timer interruption to a second period by multiplying the first period by a prescribed coefficient;
converting a wait time of a task, which waits for processing operating asynchronously with the timer interruption, into a first periodicity which is obtained by dividing the second period;
obtaining a second periodicity by dividing the first periodicity by the prescribed coefficient; and
making the computer perform the processing for determining the timer interruption on the basis of the second periodicity.

7. The non-transitory recording medium and the procedures according to claim 6, further comprising:
when the wait request is received from the task, referring to a piece of identification information related to the task which waits for processing operating asynchronously with the timer interruption; and
determining whether or not the periodicity is typically converted regarding to the task related to the wait request.

8. The non-transitory recording medium and the procedures according to claim 7, wherein the determining whether or not the periodicity is typically converted includes determining that the periodicity is typically corrected when the received identification information of the task related to the wait request and when the obtained identification information of the task related to the wait request is stored in the memory.

9. An information processing device comprising:
a reducing unit which reduces a first period of timer interruption to a second period by multiplying the first period by a prescribed coefficient;
a converting unit which converts a wait time of a task, which waits for processing operating asynchronously with the timer interruption, into a first periodicity which is obtained by dividing the second period;
an obtaining unit which obtains a second periodicity by dividing the second periodicity by the prescribed coefficient; and
a determining unit which determining the timer interruption on the basis of the second periodicity.

10. The information processing device according to claim 9 further comprises a determining unit which determines whether or not the periodicity is typically converted regarding the task related to the wait request by referring to the memory which stores the identification information related to the task which waits for the processing operating asynchronously with the timer interruption.

11. The information processing device according to claim 10, wherein the determining unit obtains the received identification information of the task related to the wait request, and
wherein the determining unit determines that the periodicity is typically converted when the obtained identification information of the task related to the wait request is stored in the memory.

12. The information processing device according to claim 9, wherein the reducing unit which periodically reads out a piece of time information from a Real Time Clock (RTC) and compares the time information to a piece of test start time information stored in the memory, and
wherein when the time information matches the test start time information, the reducing unit reduces the first period to the second period.
